(19) United States
(12) Patent Application Publication
(10) Pub. No.: US 2015/0322764 A1
(43) Pub. Date: Nov. 12, 2015

(54) Process, Method, and System for Removing Heavy Metals from Fluids

(71) Applicant: Chevron U.S.A. Inc., San Ramon, CA (US)

(72) Inventors: Dennis John O'Rear, Petaluma, CA (US); Clyde Dean Wehunt, Houston, TX (US); Gregory A. Winslow, Houston, TX (US)

(21) Appl. No.: 14/806,062

(22) Filed: Jul. 22, 2015

Related U.S. Application Data
(63) Continuation-in-part of application No. 13/896,242, filed on May 16, 2013.
Application No. 13/896,242 is a continuation-in-part of application No. 13/896,255, filed on May 16, 2013.
(60) Provisional application No. 62/034,989, filed on Aug. 8, 2014.

(51) Int. Cl. E21B 43/38; E21B 43/00; C09K 8/58; E21B 49/00

(52) U.S. Cl. CPC E21B 43/38; E21B 49/00; E21B 43/00; C09K 8/58

(57) ABSTRACT

The simultaneous control of the two forms of mercury in petroleum reservoirs (elemental and particulate HgS) is accomplished by the use of agents which react with the elemental mercury and bind the particulate HgS to the formation material: a mercury capture agent and a chemical sand control agent. The elemental control agent reacts with and adsorbs the elemental mercury. The chemical sand control agents reduce or eliminate the dislodging of fine particulate mercury from the surface of the formation material. This simultaneous control can be applied for a new well during well completion operations wherein analyses indicate the presence of mercury. This simultaneous control can also be applied to a currently producing well during a work-over when mercury is detected in the gas or crude products.

### CROSS-REFERENCE TO RELATED APPLICATIONS

This application claims benefit under 35 USC 119 of U.S. Provisional Patent Application No. 62/034,989 with a filing date of Aug. 8, 2014. This application is a continuation-in-part of U.S. patent application Ser. No. 13/896,242 and U.S. patent application Ser. No. 13/896,255 both with a filing date of May 16, 2013. This application claims priority to and benefits from the foregoing, the disclosures of which are incorporated herein by reference.

### TECHNICAL FIELD

The invention relates generally to a process, method, system, and management plan for in-situ removal and control of heavy metals such as mercury from produced fluids.

### BACKGROUND

Heavy metals such as mercury can be present in trace amounts in all types of produced fluids such as hydrocarbon gases, crude oils, and produced water. The amount can range from below the analytical detection limit to several thousand ppbw (parts per billion by weight) depending on the source.

Methods have been disclosed for in-situ treatment of fluid for removal of heavy metals such as mercury, removing the mercury right in the formation rather than to deal with it above ground, e.g., in production and refining. US Patent Publication No. 2011/0253375 discloses an apparatus and related methods for removing mercury from reservoir effluent by placing materials designed to adsorb mercury into the vicinity of a formation at a downhole location, and letting the reservoir effluent flow through the volume of the adsorbing material. US Patent Publication No. 2012/0073811 discloses a method for mercury removal by injecting a solid sorbent into a wellbore intersecting a subterranean reservoir containing hydrocarbon products. U.S. Pat. No. 8,434,556 discloses an apparatus and methods for removing mercury by placing a porous volume of materials designed to absorb the mercury at a downhole location and letting the reservoir effluent flow through the volume of materials.

There is a need for an improved method to manage, control, and remove mercury in produced fluids from a reservoir, e.g., gas, crude, condensate, and produced water.

### SUMMARY

In one aspect, the invention relates to a method to retain both elemental mercury and particulate HgS in a reservoir by use of agents which react with the elemental mercury and bind the particulate HgS to the formation material. The method comprises:

identifying a region in the reservoir containing at least 0.1 μg/Nm³ (micrograms per normal cubic meter) or at least 10 ppb in total mercury as initial concentration, and wherein the initial concentration of mercury exists in both elemental mercury Hg⁰ form and particulate HgS form; placing an elemental mercury capture compound into the region containing mercury in both elemental mercury Hg⁰ form and particulate HgS form, wherein the elemental mercury capture compound converts the elemental mercury Hg⁰ to a non-volatile mercury complex; placing a chemical sand control agent into the region containing mercury, wherein the chemical sand control agent conglomerates or consolidates the particulate HgS into packs; and producing fluids from the region; wherein mercury concentration in produced fluids recovered from the reservoir is less than 50% of the initial concentration of mercury in the produced fluids.

### DETAILED DESCRIPTION

The following terms will be used throughout the specification and will have the following meanings unless otherwise indicated.

“Trace amount” refers to the amount of mercury in the produced fluids. The amount varies depending on the source, e.g., ranging from a few μg/Nm³ to up to 30,000 μg/Nm³ in natural gas, from a few ppbw to up to 30,000 ppb in crude oil.

“Volatile mercury” refers to mercury that is present in the gas phase of well gas or natural gas. Volatile mercury is primarily elemental mercury)(Hg⁰ but may also include some other mercury compounds (organic and inorganic mercury species).

“Mercury sulfide” may be used interchangeably with HgS, referring to mercurous sulfide, mercuric sulfide, and mixtures thereof. Normally, mercury sulfide is present as mercuric sulfide with an approximate stoichiometric equivalent of one mole of sulfide ion per mole of mercury ion. Mercury sulfide is not appreciably volatile, and not an example of volatile mercury. Crystalline phases include cinnabar, metacinnabar and hypercinnabar with metacinnabar being the most common.

“Mercury salt” or “mercury complex” means a chemical compound formed by replacing all or part of hydrogen ions of an acid with one or more mercury ions. Mercury salts and mercury complexes include mercury sulfide formed by a mercury capture agent.

“Inorganic sample” refers to the inorganic portion of the subterranean formation. Examples include but are not limited to inorganic material that is brought to the surface during the drilling operation; a core sample from the wellbore, or from a nearby boring to analyze the subterranean structure and the composition of the rock matrix in the region of the wellbore; drill cuttings recovered from a production zone of a subterranean formation; drilling mud.

“Chemical sand control agent” refers to a compound designed to partially or completely coat particulates or particles in the formation, changing the aggregation, agglomeration or conglomeration propensity or potential and/or zeta potential of the particles for strengthened attraction between the particles, causing the conglomeration or consolidation of the particles. In one embodiment, the chemical sand control agent is of the conglomeration type. In another embodiment, the chemical sand control agent is of the consolidation type.

“Pore volume” or PV refers to the pore volume of the subterranean formation, which is total volume of the formation minus the volume occupied by rock. To calculate the total PV of a subterranean formation consisting of several regions, one can sum the PV's for each region within the formation. PV can also be determined by the swept volume between an injection well and a production well, and can be determined by methods known in the art.

“Subterranean formation” or formation refers to a region of a hydrocarbon-containing reservoir, which may include oil, or other gaseous or liquid hydrocarbons, water, or other fluids. A formation may include but not limited to geothermal reservoirs, petroleum reservoirs, sequestering reservoirs, and the like.

“Produced fluid” or production fluid refers to a mixture of oil, gas and water in formation fluid that flows to the surface of an oil well from a reservoir. The production fluid may leave the well bore as a liquid, gas or combination thereof. In one embodiment, produced fluid refers to hydrocarbons for recovery from a formation.

“Region in the reservoir” refers to a reservoir at a specific depth and location which contains or contained gaseous or liquid hydrocarbons, and which samples have been collected and analyzed for mercury, e.g., core samples in which the total mercury is measured in ppb by weight, or a sample of crude and/or condensate in which the total mercury is measured in ppb by weight, or a sample of gas in which the total mercury is measured in μg/Nm³.

Mercury Types for Removal/Control:

It is found that mercury in a reservoir and the produced fluids from the reservoir, i.e., a region in the reservoir, exists in trace amounts in two primary forms: elemental mercury and particulate HgS. Other forms such as dialkyl mercury complexes, mercury chloride salts, mercuric oxide, etc., can also be present in minor amounts. Without wishing to be bound by theory, the presence of the two forms of mercury in reservoirs is explained as follows. A typical crude oil initially migrates to an underground reservoir. Originally this crude contains a range of sulfur species including mercaptans, disulfides, thiophenes and other aromatic sulfur compounds.

Elemental mercury vapor enters the reservoir and reacts in the oil phase with some of the sulfur species (e.g., mercaptans, disulfides, hydrogen sulfide, etc.) but does not react with thiophenes or aromatic sulfur compounds. The product from this reaction is nanometer-size particles of metacinnabar that adhere to the outside of the formation material or which form micron-sized clusters. Since these metacinnabar particles form in the hydrocarbon phase and not an aqueous phase, they do not mineralize to large crystals, but remain very small. When the reactive sulfur species in the crude are consumed, elemental mercury does not react further and accumulates as such in the reservoir.

Evidence for this model is shown by the sulfur distribution in high-mercury crudes. It is found that such crudes contain thiophenes and aromatic sulfur species, but typically less than 1 ppm mercaptans and disulfides, and with low levels of hydrogen sulfide. Analysis of the particulate residues from crudes by EXAFS (“Extended X-Ray Absorption Fine Structure”) shows only the presence of metacinnabar and related mercury dithiol precursor. The EXAFS analysis also shows that the metacinnabar particles have mercury coordination numbers less than the expected value of 4, consistent with particles having sizes of a few nanometers, or else being highly disordered. TEM studies of these residues show the presence of nanometer-size particles of mercuric sulfide on the surface of micron-sized formation particles, or as separate particles.

Elemental mercury distributes primarily to the gas and crude oil. Elemental mercury can be present in many products and streams in a gas processing plant. In gas production, elemental mercury may condense in pipelines, creating a mercury-rich sludge waste. Upon stabilization to remove light gases from crude oil, the volatile elemental mercury partitions to the gas phase.

Mercury is present in natural gas as volatile mercury, including elemental mercury Hg⁰, in levels ranging from about 0.01 μg/Nm³ to 5000 μg/Nm³, which mercury content may be measured by various conventional analytical techniques known in the art, including but not limited to cold vapor atomic absorption spectroscopy (CV-AAS), inductively coupled plasma atomic emission spectroscopy (ICP-AES), X-ray fluorescence, or neutron activation. If the methods differ, ASTM D 6350 is used to measure the mercury content.

Particulate HgS comes from a region in the reservoir may have a coating of nanometer-size HgS particles or from the aggregates of the nanometer-size HgS particles. It is found that particulate HgS concentrates in the finest size fraction (<100 mesh) of formation material. Particulate HgS remains in the crude oil upon stabilization, or drops out as sediment that must be managed as a mercury-containing hazardous waste. The mercury-rich sediments may be found in tank bottoms from refinery crude storage, and from various vessels in crude production operations.

Production of oil and gas is usually accompanied by the production of water. The produced water may consist of formation water (liquid water present naturally in the reservoir), or water previously injected into the formation. Produced water may leave as a vapor (steam) and then condenses is known as condensed water. Either form of produced water can contain particulate HgS, which may be processed by filtration, centrifugation or reinjection back into the formation in order to manage the mercury and other impurities.

The invention relates to an improved method and a system to manage, control, and remove mercury in produced fluids, e.g., gas, crude, condensate, and produced water, from a region in the reservoir indicated to have mercury present, with in-situ removal of the mercury from the produced fluids and retention of the mercury in the formation. The removal and retention of mercury is carried by a combination of a mercury capture agent for the removal of elemental mercury, and a sand control agent for the retention of particulate HgS in the formation.

Reservoirs for Mercury Management/Control Plan:

There are various ways to tell if a reservoir has a sufficient presence of mercury that would merit a mercury management/control plan. In one embodiment, the mercury content of at least one inorganic sample from a newly investigated production zone is analyzed. In another embodiment, the mercaptans content of at least one crude oil sample recovered from the newly investigated production zone is analyzed. In yet another embodiment, a gaseous hydrocarbon sample recovered from a newly investigated production zone is analyzed for hydrogen sulfide (H₂S) content, as indication of the mercury content of natural gas.

The mercaptans react with elemental mercury to form mercuric sulfide at conditions in the subterranean formation. Thus high levels of mercaptans suggest that elemental mercury may not be present. Conversely, low levels of mercaptans accompanying mercury in the inorganic matrix suggest that elemental mercury may be present and will contaminate the gas product. Methods for recovering liquid hydrocarbon samples from a hydrocarbon-bearing zone of a subterranean formation during well completion are well known.

Crude oil samples can be analyzed for mercaptans sulfur using a standard method, such as ASTM3227. Analysis of inorganic samples (e.g., core samples, drilling fluids, or cutting samples) for mercury levels can be done using any of the following tests known in the art: Drill Stem Tests (DST); Modular formation Dynamic Test (MDT); and Repeat Formation Test (RFT). H₂S can be measured using a standard method such as ASTM D4084-07 (2012).

In one embodiment, the mercury management/control plan is implemented when there is sufficient presence of mercury for a new production zone, e.g., when the mercury content of core samples, drilling fluids, or cutting samples is at least 10 ppb (median or average level from samples), and mercury is present in the samples in both elemental Hg and particulate HgS form. In another embodiment, a plan is implemented when the mercury level is at least 100 ppb, or for example at least 500 ppb. In yet another embodiment, a mercury management plan is implemented when the mercury content of the gas recovered from Drill Stem Tests (DST), Modular formation Dynamic Test (MDT) or Repeat Formation Test (RFT) is at least any of 0.1 μg/Nm3 or; 1 μg/Nm3 or more; or 10 μg/Nm3 or more. With respect to measurements from crude or condensate recovered from any of Drill Stem Tests (DST), Modular formation Dynamic Test (MDT) or Repeat Formation Test (RFT), a mercury measurement plan is implemented when the mercury level is any of at least 10 ppb; at least 100 ppb; and at least 500 ppb.

The plan can also be implemented for in-situ mercury removal in an existing well with a sufficient presence of mercury, e.g., when it is found that the mercury content of the crude or condensate recovered from the well is any of: at least 10 ppb; at least 100 ppb; and at least 500 ppb, and wherein mercury is present in the samples in both elemental Hg and particulate HgS form. In another embodiment, the plan is implement when it is determined that the mercury content of the gas recovered from the well is any of at least 0.1 μg/Nm³; at least 1 μg/Nm³; and at least 10 μg/Nm³.

Mercury Management/Control Plan:

In many producing wells, unpredicted sand production may occur during the life of the wells for many reasons, necessitating sand control methods including gravel pack, frac pack, expandable screens, stand-alone screens, chemical sand consolidation, and chemical sand conglomeration. If not controlled by being retained in the formation, sand can cause erosion of equipment and settle as of sediment in product tanks Examples of commercially available methods for sand control as part of well completion or well production systems include Halliburton (SandTrap™ service), Schlumberger (SandLock™ technique), and Weatherford (SandAid™ technology).

In wells with high mercury levels, the amount of sediments is insignificant, and sand control methods using chemical sand control agents are not employed as there is no need for sand control. However, in one embodiment of the invention for production wells in which sand control is not needed but with a sufficient presence of mercury, elemental mercury and particulate HgS in the produced fluids can be simultaneously removed and controlled with an elemental mercury capture compound and an additive known and used in well completion, a chemical sand control agent.

The elemental mercury capture compound and the chemical sand control agent can be injected into the formation in the same injection stream or as separate injection streams; in liquid form, a slurried/dissolved form, or a solid form, or in particulate form as a coat (coating) on particulates as coated particulates. In one embodiment, the chemical sand control agent is dispersed into the formation by use of propellant gas fracturing, a technique known in the industry.

The chemical sand control agent can be injected into the formation as a single component or as multiple-component form, e.g., a tackifying compound or pre-cured, partially cured, or curable compound (in liquid form or particulates), followed by the injection of a catalyst material to cause the partially cured or curable compound to cross-link under the stress and temperature conditions in the formation. The elemental mercury capture compound reacts with the elemental mercury and convert it into a non-volatile solid form. The chemical sand control agent helps retain the non-volatile mercury and bind it to the formation material, not dislodged by the hydraulic forces of the produced fluids that flow past the solid during production.

The injection of the elemental mercury capture compound and chemical sand control agent as coated particulates or a fluid in an injection stream depends on various factors, including but not limited to the permeability of the formation. Tight reservoirs are reservoirs that must be hydraulically fractured, e.g., reservoirs have a permeability of 1 mD (milliDarcy) or less, such as 0.1 mD or less such as shale formations. Some reservoirs do not need to be hydraulically fractured, e.g., reservoirs having a permeability of more than 1 mD, such as 10 mD or more; or such as 100 mD or more, such as unconsolidated sandstone reservoirs.

Particulate Materials:

The particulates for being coated with the elemental capture compound and/or chemical sand control agent can be in the form used in the art form making proppants, including but not limited to sand, sand zeolites, alumina based materials, spent catalyst, alumina silica industrial processed waste, clay, ceramic beads, carbon-based particulates such as graphite, titanium dioxide, calcium silicate, talc, boron, zirconia, hollow glass spheres, solid glass spheres, molecular sieve, and mixtures thereof.

The term coat or coating does not imply any particular degree of coverage of elemental mercury capture compound or chemical capture agent on the particulate. In one embodiment, the coated particulate size distribution is any of 10-20 mesh; 20-40 mesh; 40-60 mesh; 10-70 mesh. In another embodiment, the coated particle size has a mean particle size ranging from about 45 to about 20 microns, and combinations thereof. In yet another embodiment, the coated particulates have an average particle size ranging from any of about 50 to 3000 microns, and 100 to 2000 microns.

Chemical Sand Control Agent:

Suitable chemical sand control agent is selected based on a number of criterial, inter alia, pumping considerations for injection deep into the formation for the control/management of particulate Hg, the formation conditions including temperature of the formation, viscosity, cost, and safety issues.

In one embodiment, the chemical sand control agent comprises an amine and a phosphate ester, which modifies surfaces of solid materials such as particulate HgS or portions thereof, altering the chemical and/or physical properties of the surfaces. The altered properties permit the particulate HgS surfaces to become self-attracting or to permit the surfaces to be attractive to material having similar chemical and/or physical properties.

In one embodiment, the chemical sand control agent comprises at least one of aqueous tackifying treatment fluids, a curable agent, a partially cured or non-curable resin, and mixtures thereof, in a suitable solvent that is compatible with the chemical sand control agent and helps provide the desired viscosity effect. In one embodiment, the tackifying treatment fluid is first injected into the formation, subsequently followed by the injection of the curable resin or the non-curable resin. Exemplary solvents include but are not limited to, butylglycidyl ether, dipropylene glycol methyl ether, butyl bottom alcohol, dipropylene glycol dimethyl ether, diethyleneglycol methyl ether, ethyleneglycol butyl ether, methanol, butyl alcohol, isopropyl alcohol, diethyleneglycol butyl ether, propylene carbonate, d-limonene, 2-butoxy ethanol, butyl acetate, furfuryl acetate, butyl lactate, dimethyl sulfoxide, dimethyl formamide, fatty acid methyl esters, and combinations thereof.

Suitable tackifying treatment fluids are generally are charged polymers that comprise compounds that will form a non-hardening coating (by themselves or with an activator) on particulates. The aqueous tackifying agent may enhance the grain-to-grain contact between HgS particulates within the formation, helping bring about the consolidation of the HgS particulates into a stabilized mass. Examples of aqueous tackifying agents suitable for use in the present invention include, but are not limited to, acrylic acid polymers, acrylic acid ester polymers, acrylic acid derivative polymers, acrylic acid homopolymers, acrylic acid ester homopolymers (such as poly(methyl acrylate), poly(butyl acrylate), and poly(2-ethylhexyl acrylate)), acrylic acid ester co-polymers, methacrylic acid derivative polymers, methacrylic acid homopolymers, methacrylic acid ester homopolymers (such as poly(methyl methacrylate), poly(butyl methacrylate), and poly(2-ethylhexyl methacrylate)), acrylamido-methyl-propane sulfonate polymers, acrylamido-methyl-propane sulfonate derivative polymers, acrylamido-methyl-propane sulfonate co-polymers, and acrylic acid/acrylamido-methyl-propane sulfonate co-polymers, and combinations thereof.

In one embodiment, the curable resin is a composition having a viscosity of less than 100 cP and preferably less than 20 cP, capable of consolidating the HgS particulates into a stabilized mass. Sand control agents often aim to enhance the mechanical strength of unconsolidated formation. In one embodiment with the use of chemical sand control agents in conventional formations for retention of HgS fines, the properties of the chemical sand control agent are adapted for the application. In one embodiment, the curable resin has a viscosity of less than 10 cP, and preferably less than 5 cP. The lower viscosity provides a thinner coating and thus reduces the loss in reservoir performance. It also permits the resin to penetrate deeper into the formation. In one embodiment, the curable resin is selected from the group of two component epoxy based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof.

Suitable non-curable resins for use as chemical sand control agents include additives that form non-hardening coating, or form a hardened coating when combined with a material capable of reacting with the non-curable resin such as a tackifying compound. Examples include polyacids and a polyamine, such as mixtures of C₃₆ dibasic acids containing some trimer and higher oligomers and also small amounts of monomer acids that are reacted with polyamines; liquids and solutions of polyesters, polycarbonates and polycarbamates, natural resins such as shellac and the like.

In one embodiment, the chemical sand control agent is a traditional resin, e.g., epoxy or furan resin, having sufficient adhesive properties to hold the HgS particulate in place. Other examples of resin include organic resins such as bisphenol A diglycidyl ether resin, butoxymethyl butyl glycidyl ether resin, bisphenol A-epichlorohydrin resin, polyepoxide resin, novolak resin, polyester resin, phenol-aldehyde resin, urea-aldehyde resin, furan resin, urethane resin, a glycidyl ether resin, and combinations thereof.

The chemical sand control agent can be injected in the formation along with a diluent. In one embodiment when applied to retain the structure of unconsolidated formations, the agent is added in amounts over 15%. For the purpose of control of particulate HgS, lower concentrations can be employed. In one embodiment, the concentration of the sand control agent in the diluent is in the range of 0.1 wt %-14 wt. %. In another embodiment, the concentration of the sand control agent in the diluent is in the range of 1 wt %-10 wt. %. A lower concentration reduces the cost of the agent and permits it to be dispersed more widely into the formation.

Disclosures of suitable chemical sand control agents can be found in U.S. Pat. No. 8,443,885; U.S. Pat. No. 7,404,311; and US Patent Publication no. 20120205107, the relevant sections are incorporated herein by reference.

Elemental Mercury Capture Compound:

In one embodiment, the elemental mercury capture compound (“fixing agent”) is a compound for forming non-volatile complexes with mercury, e.g., mercuric sulfide, mercuric selenide, mercuric arsenide, etc. The non-volatile mercury species is incorporated in a solid that is retained in the formation and is not dislodged by the hydraulic forces of the gas, crude and water that flow past the solid during production.

Examples of elemental mercury capture compounds include but are not limited to selenium compounds (benzene selenol, selenous acid), metals (aluminum, zinc, copper, brass, bronze), metal sulfides (iron sulfides, copper sulfides, zinc sulfides), and sulfur-based compounds such as hydrogen sulfide, bisulfide salt, or a polysulfide that react with mercury, forming insoluble complexes, e.g., mercury sulfide. In another embodiment, the sulfur-based compound is an organic compound containing at least a sulfur atom that is reactive with mercury as disclosed in U.S. Pat. No. 6,685,824, the relevant disclosure is included herein by reference. Examples include but are not limited to organic polysulfide such as di-tertiary-nonyl-polysulfide, dithiocarbamates, sulfurized olefins, mercaptans, thiophenes, thiophenols, mono and dithio organic acids, and mono and dithiesters.

In another embodiment, the elemental mercury capture compound is an oxidant, e.g., chlorine, iodine, fluorine or bromine, alkali metal salts of halogens; iodide of a heavy metal cation; ammonium iodide; iodine-potassium iodide; an alkaline metal iodide; etheylenediamine dihydroiodide; hypochlorite ions; vanadium oxytrichloride; Fenton's reagent; hypobromite ions; chlorine dioxine; iodate IO₃; monopersulfate; alkali salts of peroxide like calcium hydroxide; peroxidases that are capable of oxidizing iodide; oxides, peroxides and mixed oxides, including oxyhalites, their acids and salts thereof; sodium perborate, potassium perborate, sodium carbonate perhydrate, potassium peroxymonosulfate, sodium peroxocarbonate, sodium peroxodicarbonate, and mixtures thereof.

In one embodiment, the elemental mercury capture compound comprises a complexing agent to further form complexes with the elemental mercury. Examples include hydrazines, sodium metabisulfite (Na₂S₂O₅), sodium thiosulfate (Na₂S₂O₃), thiourea, thiosulfates (such as Na₂S₂O₃), ethylenediamine-tetra-acetic acid, and combinations thereof.

Other examples of elemental mercury capture compounds which can convert elemental mercury into a non-volatile species are disclosed in U.S. Pat. No. 8,434,556B2, WO2013173634 and US20120322696, the relevant sections are incorporated herein by reference.

The elemental mercury capture compound is incorporated into the composition used as the chemical sand control agent, e.g., as a solid dispersed in the polymer, as a liquid dispersed in the polymer, or as a monomer within the polymer. For example of an embodiment where the chemical sand control agent is urea-formaldehyde resin, by substituting part or all of the urea with thiourea, a resin can be made that both captures elemental mercury and prevents the dislodging of particulate HgS, retaining mercury in the formation and reducing mercury level in the produced fluid. Methods for synthesizing urea-thiourea formaldehyde resin is disclosed in U.S. Pat. No. 3,308,098, incorporated herein by reference in its entirety.

The elemental mercury capture compound and the chemical sand control agent can be an injection stream (as one stream or different streams) in a number of ways known in the art including but not limited to by dissolution in a mixer, and added to a distribution system connecting to one or more injection wells. The components can be added into an injection stream of fresh water, or recycled water, or mixtures of fresh water, formation water, and recycled water from the formation. The injection stream(s) of elemental mercury capture compound and the chemical sand control agent can be added to the same or different injection wells, and the same or different regions of the formation which are in fluid communication. The elemental mercury capture compound removes mercury from the produced fluid and retain it in the formation. The sand control agent helps retain particulate HgS (and consequently removing from the produced fluid) by preventing the dislodging of HgS particles.

The mercury capture agent can be added to the formation in an amount sufficient for a molar ratio of capture agent to mercury Hg⁰ of at least any of 2:1; from 5:1 to 10,000:1; from 10:1 to 5,000:1; and from 100:1 to 2,000:1. The mercury capture agent in one embodiment removes and/or reduces the Hg⁰ concentration in the produced fluids recovered from the formation.

The amount of chemical sand control agent added for the consolidating/conglomerating of HgS particles in the formation is sufficient to coat a substantial portion of the particles, or to function as a “bridge” between the particles that are in close proximity to one another to conglomerate them, and help retain them in the formation—meaning for the particles to retain at least 10 feet extending radially away from a well bore, in conglomerated or consolidated “packs.” In one embodiment, at least 50% of the HgS and non-volatile mercury complexes are retained in the formation in the form of packs, with each pack having an average total volume of at least three times the average volume of the HgS particle originally present in the formation.

The treatment for the removal of elemental mercury and particulate HgS in the formation can be done prior to commencement of hydrocarbon production, or it can also be done after production has begun to treat and remove mercury from the produced fluids recovered from the formation. Suitable flow rates of the injection stream(s) containing the chemical sand control agent and mercury capture agent may be readily determined by persons skilled in the art, ranging from 0.1 to 2 times the PV of the formation.

The treatment is preferably carried out by injecting the chemical sand control agent and mercury capture agent into a formation for a sufficient of time and at a pressure sufficient to enter the pores of the formation. The injection can be for a long interval for a plurality of intervals. After injection, the well can be shut in for a period of time which is dependent upon factors such as the nature of the formation, the amount of Hg removal desired, the concentration of the chemical sand control agent in the formation to cause the consolidation/conglomeration of the particulate HgS, the temperature of the formation, and the pressure of the formation. The shut-in time can range from 1 to 48 hours in one embodiment, at least 2 hrs. in another embodiment, and from 3 to 10 hours in yet another embodiment. The simultaneous in-situ treatment with chemical sand control agent and elemental mercury capture agent reduces the concentration of mercury in produced fluids recovered from the formation at least any of 25%, 40%, 50%, and 75% (as compared to recovered produced fluids without any treatment).

### EXAMPLES

The following illustrative examples are intended to be non-limiting.

### Example 1

A sample of volatile Hg⁰ in simulated crude was prepared to simulate crude as it exists in a reservoir and which contains dissolved elemental mercury. This is not meant to represent stabilized crude, but a non-stabilized crude that exists within a reservoir and which contains elemental mercury. First, five grams of elemental mercury Hg⁰ was placed in an impinger at 100° C. and 0.625 SCF/min of nitrogen gas was passed over through the impinger to form an Hg-saturated nitrogen gas stream. This gas stream was then bubbled through 3123 pounds of Superla® white oil held at 60-70° C. in an agitated vessel. The operation continued for 55 hours until the mercury level in the white oil reached 500 ppbw by a Lumex™ analyzer. The simulated material was drummed and stored. During storage the mercury content gradually decreased due to evaporation and adsorption on the drum walls.

### Example 2

This example is to strip volatile Hg⁰ from the simulated reservoir crude, showing that elemental mercury dissolved in simulated crudes is volatile. Correspondingly, mercury in crudes which is not volatile must be some other species besides volatile elemental mercury. First, 75 ml of the simulated reservoir crude from Example 1 was placed in a 100 ml graduated cylinder and sparged with 300 ml/min of nitrogen at room temperature. The simulated crude had been stored for an extended period of time, e.g., months or days, and its initial value of mercury had decreased to about 369 ppbw due to vaporization (at time 0). The mercury in this simulated crude was rapidly stripped consistent with the known behavior of Hg⁰, as shown in Table 1. The effective level of mercury at 60 minutes is essentially 0 as the detection limit of the Lumex™ analyzer is about 50 ppbw.

TABLE 1

| Time, min | Mercury, ppbw |
|---|---|
| 0 | 369 |
| 10 | 274 |
| 20 | 216 |
| 30 | 163 |
| 40 | 99 |
| 50 | 56 |
| 60 | 73 |
| 80 | 44 |
| 100 | 38 |
| 120 | 11 |
| 140 | 25 |
| Pct Volatile Hg | 80 |

Superla® white oil is not volatile and there were no significant losses in the mass of the crude by evaporation. Therefore, the mercury analyses of the stripped product did not need to be corrected for evaporation losses. The mercury in this crude is volatile. Filtering this simulated crude through a 0.45 micron syringe filter to avoid losses of volatile mercury resulted in no change in the mercury content. This simulated reservoir crude is an example of a volatile mercury crude and a non-particulate mercury crude.

### Examples 3-6

These examples are to determine the % volatile mercury in crudes by stripping, showing that that the mercury in various stabilized condensates and crudes is not volatile and therefore must be some other species besides volatile elemental mercury. The mercury content in the vapor space of these four samples was measured by a Jerome analyzer and found to be below the limit of detection. This indirect qualitative method indicates that there is no volatile mercury in these samples.

The initial total mercury content of the four samples was determined and then the samples were stripped as indicated. The loss of weight of crude by evaporation was determined, and the total mercury in the stripped crude was measured. The percent volatile mercury was determined from these values based on a corrected value for the stripped total mercury to account for losses in the crude by evaporation using the following formula:

% volatile Hg=100*(Total Hg in the original sample)−[(100−% Oil Loss)*(Hg in stripped sample)/100]/(Total Hg in the original sample)

All samples contained predominantly non-volatile mercury. Results are summarized in Table 2.

TABLE 2

| | Experiment | | | |
|---|---|---|---|---|
| | 3 | 4 | 5 | 6 |
| Sample ID | SEA-C1 | SEA-C2 | SEA-C3 | NAR-2 |
| Volatile Hg by Jerome, | 0.00 | 0.00 | 0.00 | 0.00 |
| μg/m3 | | | | |
| Total Hg by Lumex | 2,102 | 1,388 | 1,992 | 9,050 |
| (or CEBAM), ppb | | | | |
| Hg after 1 hr RT | 2,357 | 1,697 | 2,787 | 8,951 |
| stripping, ppb | | | | |
| Oil loss after 1 hr RT | 14.00 | 10.83 | 30.01 | 16.01 |
| stripping, wt % | | | | |
| Percent Volatile Hg | 4 | −9 | 2 | 17 |

The results show that the mercury in stabilized crudes and condensates is not volatile and is not elemental mercury. These results are in contrast to the results in Example 2 in which elemental mercury could be stripped from the simulated crude.

### Examples 7-16

Examples 7 to 16 show evidence of particulate mercury in crudes and condensates, and that the mercury in various stabilized condensates and crudes is particulate and can be removed by filtration. The particle size distribution of the Hg-containing particles varies significantly between samples. Ten crude and condensate sample were vacuum filtered through 47 mm filters with pore sizes of 20, 10, 5, 1, 0.45 and 0.2 μM. The temperature of the filtration was set above the crude pour point. The total mercury in the crudes, condensates and their filtrates was determined by Lumex. The amount of mercury in each size fraction was determined by comparing the amount removed in successive filter sizes. On occasion, this resulted in negative numbers, which should be interpreted as meaning that there was little or no particulate mercury in this size range. Results are summarized in Table 3.

TABLE 3

| | | Crude | Percent Hg removed in each size fraction | | | | | | | % |
|---|---|---|---|---|---|---|---|---|---|---|
| Ex. | Filtration | Hg, | >20 | 10-20 | 5-10 | 1-5 | 0.45-1 | 0.2-0.45 | <0.2 | <0.45 |
| # | Temp, C. | ppb | μM % | μM % | μM % | μM % | μM % | μM % | μM % | μM |
| 7 | 65 | 1,947 | 42 | 10 | 1 | −4 | 34 | 1 | 16 | 17 |
| 8 | 70 | 1,256 | 35 | 18 | 21 | 7 | 4 | 0 | 16 | 16 |
| 9 | Room T | 2,102 | 89 | 5 | −3 | 3 | 6 | 1 | 0 | 1 |
| 10 | 48 | 1,510 | 3 | 0 | 8 | 12 | 3 | −2 | 76 | 74 |
| 11 | 70 | 230 | 19 | 10 | 19 | −2 | 25 | 1 | 28 | 29 |
| 12 | 70 | 360 | 16 | 8 | 9 | −1 | 24 | 2 | 43 | 45 |
| 13 | 70 | 429 | 9 | −8 | 19 | −2 | 32 | 2 | 48 | 50 |
| 14 | 70 | 940 | 14 | 59 | 14 | 0 | 5 | 0 | 8 | 8 |
| 15 | 40 | 2,021 | 11 | 3 | 15 | −14 | 29 | −1 | 57 | 56 |
| 16 | Room T | 9,050 | 16 | 16 | 11 | 32 | 20 | 1 | 4 | 5 |

None of these samples contained a significant amount of elemental mercury as determined by stripping with nitrogen at room temperature for one hour. The data shows that mercury in most of these samples is particulate and can be removed by filters 0.2 microns and larger. The size distribution of the particulate HgS varies significantly between samples. The condensate in Example 4 appears to be different, but the mercury in this condensate is not volatile elemental mercury it is believed to be very fine particulate HgS.

### Examples 17 to 21

In these examples, metacinnabar are determined as the Hg species in stabilized crude. The examples show that the predominant form of mercury in solid residues from various stabilized crudes is metacinnabar. The metacinnabar particles are either very small (nanometer scale), highly disordered, or both.

Solid residues from several crudes were analyzed by EXAFS to determine the composition of the solids components. The mercury coordination number (CN) was also measured. Efforts were made to look for other species, but they could not be detected and must be present at levels much less than 10%. The search-for species include: elemental mercury (on frozen samples), mercuric oxide, mercuric chloride, mercuric sulfate, and Hg3S2Cl2. Also the following mineral phases were sought and not found: Cinnabar, Eglestonite, Schuetite, Kleinite, Mosesite, Terlinguite. Results are shown in Table 4, showing a summary of Hg species identified in the samples and the calculated first shell coordination number for each Hg species.

TABLE 4

| | | | Coordination |
|---|---|---|---|
| Example | Sample | Species (%) | number |
| 17 | SEA-C1 | B-HgS (101) HgSe (10) | 2.61 ± 0.26 |
| | (toluene washed) | | |
| 18 | SEA-C3 | B-HgS (91) Hg-(SR)₂ (24) | 2.40 ± 0.98 |
| | (not washed) | | 1.22 ± 0.85 |
| 19 | NAR-21 | B-HgS (104) | 2.61 ± 0.17 |
| 20 | SEA-C5 | B-HgS (139) | 3.46 ± 0.21 |
| 21 | SEAM | B-HgS (129) | |

The percentages of mercury in the samples were calculated by comparison to standards and with measurement of the mercury content of the sample. Metacinnabar (B—HgS) is the predominant species for all stabilized crudes obtained from around the world. On occasion traces of mercury selenide are seen. Higher amounts of related mercury dithiol (Hg—(SR)2) can be seen in samples that are not washed with toluene solvent. The dithiol is believed to be an intermediate product from the reaction between elemental mercury and mercaptans. It eventually condenses to form metacinnabar which adsorbs on the surface of the formation material. The standard used for analysis of the dithiol was HgCysteine. The coordination numbers below 4 indicate that the metacinnabar crystallites are either very small (nanometer scale), or are very poorly crystalized, or both.

### Examples 22 to 34

The examples show the capture of elemental mercury in simulated reservoir crude. In these examples, performance of various elemental mercury capture agents when dispersed on Ottawa beach sand was evaluated, simulating the incorporation of these compounds on a proppant for reacting with elemental mercury and preventing it from leaving the formation.

The preparation of the treated sand was as follows: approximately 2 grams of Ottawa Beach sand was weighed out on watch glasses. The elemental mercury capture compounds were dissolved in an appropriate solvent. The treated sands were in a 65 C oven overnight. The treated sand was tested for effectiveness in capturing elemental mercury by using the simulated reservoir crude of Example 1. An oil bath was heated to 90° C. The proppant (treated sand) was added to a 40 ml vial. 20 ml of the simulated reservoir crude from example 1 was added. The vials were capped, shaken and placed in the hot oil bath. They were shaken periodically and then allowed to stand overnight in the hot oil bath. In the morning, the supernatant fluid was samples and the Hg content determined by Lumex. The samples were then stripped with N2 for one hour to remove any unreacted volatile elemental mercury. The supernatant fluid and measure the Hg content by Lumex. This is the amount of non-strippable mercury that remains dispersed in the simulated crude. The percent mercury which is evaporated (volatile elemental mercury) is calculated from the initial mercury content and the difference in the mercury contents before and after stripping.

The percent mercury which remains in the oil is calculated from the initial mercury content and the mercury contents after stripping. The percent mercury in the solid is calculated by difference between 100 and the percent mercury in the oil and percent evaporated mercury. The results are summarized below in Table 5:

TABLE 5

| | Elemental Mercury Capture | | Wt % | % Hg in | % Hg in | % Hg |
|---|---|---|---|---|---|---|
| Example | Agent | Solvent | Agent | Solid | Oil | Evaporated |
| 22 | Ottawa Beach Sand Only | None | 0 | 0 | 0 | 100 |
| 23 | NALMET 1689 additive | Water | 4.39 | 5 | 5 | 90 |
| 24 | IRGALUBE additive | Water | 0.53 | 1 | 13 | 86 |
| 25 | Am. Diethyldithiocarbamate | Water | 2.20 | 58 | 9 | 33 |
| 26 | Na Diethyldithiocarbamate | Water | 2.94 | 0 | 67 | 33 |
| 27 | 2,3 dimercaptosuccinic acid | Water | 0.12 | 3 | 0 | 97 |
| 28 | 2,3, mercaptopropanol 97% | Water | 0.13 | 5 | 2 | 93 |
| 29 | Benzeneselenol | Water | 0.12 | 33 | 7 | 60 |
| 30 | Selenious acid | Water | 0.15 | 11 | 2 | 87 |
| 31 | Thiourea | Water | 0.15 | 90 | 0 | 10 |
| 32 | elemental sulfur | Hexane | 0.34 | 0 | −5 | ~100 |
| 33 | Phenyl disulfide | Hexane | 0.24 | 0 | 1 | 99 |
| 34 | Iodine Crystalline | MeOH | 0.39 | 0 | −1 | 100 |

Chemicals which were effective in capturing elemental mercury include ammonium diethyldithiocarbamate, benzene selenol, and thiourea. Sodium diethyldithiocarbamate, and to a lesser extent IRGALUBE captured elemental mercury but it remained dispersed in the simulated crude. Presumably this was in the form of fine particulate metacinnabar or related species.

### Examples 35 to 50

The examples illustrate the performance of various sulfur compounds as elemental mercury capture agents when dispersed on various solids. In these examples fifteen alternative solids were prepared and tested for effectiveness as elemental mercury capture agents. These consisted of three elemental mercury capture agents (sodium thiosulfate, sodium polysulfide, and ammonium polysulfide) dispersed on five solids (Darco Carbon Diatomaceous Earth, FCC Catalyst, SiO₂ Gel, Al₂O₃ Extrudate). The capture agents were dissolved in water, impregnated on the solids, and dried. The samples were mixed with the simulated reservoir crude from Experiment 1 overnight on a spinning wheel. Then filtered and the mercury content measured. Results are shown in Table 6

TABLE 6

| | | Sulfur Content | Hg content, | % Hg |
|---|---|---|---|---|
| Example | Solid + Elemental Hg Capture Agent | Of Solid, Wt % | ppb | Removed |
| 35 | None | 0.00 | 289 | 24.08 |
| 36 | Darco + Thiosulfate | 5.99 | 0.30 | 99.92 |
| 37 | DE + Thiosulfate | 6.01 | 276 | 27.33 |
| 38 | FCC + Thiosulfate | 4.93 | 263 | 30.82 |
| 39 | Silica Gel + Thiosulfate | 5.37 | 215 | 43.40 |
| 40 | Al₂O₃ Ext. + Thiosulfate | 5.17 | 14.40 | 96.21 |
| 41 | Darco + Sodium Polysulfide | 18.55 | 0.64 | 99.83 |
| 42 | DE + Sodium Polysulfide | 17.00 | 241 | 36.48 |
| 43 | FCC + Sodium Polysulfide | 12.88 | 128 | 66.23 |
| 44 | Silica Gel + Sodium Polysulfide | 15.80 | 133 | 65.00 |
| 45 | Al₂O₃ Ext. + Sodium Polysulfide | 14.97 | 168 | 55.76 |
| 46 | Darco + Ammonium Polysulfide | 27.34 | 0.56 | 99.85 |
| 47 | DE + Ammonium Polysulfide | 27.93 | 1.86 | 99.51 |
| 48 | FCC + Ammonium Polysulfide | 19.41 | 0.67 | 99.82 |
| 49 | Silica Gel + Ammonium Polysulfide | 25.38 | 0.43 | 99.89 |
| 50 | Al₂O₃ Ext. + Ammonium Polysulfide | 16.69 | 0.42 | 99.89 |

The ammonium polysulfide treated solids performed consistently well, with very low levels of mercury remaining in solution. These low levels of mercury were below the limit of detection by Lumex and were measured by CEBAM. The carbon supports uniformly worked well, as did the alumina extrudate with sodium thiosulfate.

### Example 51

A gas well producing 40 BCF/year of gas that contains 500 μg of Hg/m³ is given a work-over that includes adding 300,000 pounds of proppant. The proppant contains 1 wt. % sulfur in the form of ammonium polysulfide. Gas is produced for 15 years until the stoichiometry of 1 mole of Hg per mole of sulfur in the proppant is reached. During this time, the mercury content of the gas is expected to be reduced to below 100 μg of Hg/m³. When the mercury content of the gas increases above 100 μg of Hg/m³, the well is worked over again with a new charge of sulfur-treated proppant.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

As used herein, the term “include” and its grammatical variants are intended to be non-limiting, such that recitation of items in a list is not to the exclusion of other like items that can be substituted or added to the listed items. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A process for recovering produced fluids from a region of a reservoir while simultaneously removing mercury from the produced fluids, comprising:
identifying a region in the reservoir containing at least 0.1 μg/Nm³ or at least 10 ppb in total mercury as initial concentration, and wherein the initial concentration of mercury exists in both elemental mercury Hg⁰ form and particulate HgS form;
placing an elemental mercury capture compound into the region containing mercury in both elemental mercury Hg⁰ form and particulate HgS form, wherein the elemental mercury capture compound converts the elemental mercury Hg⁰ to a non-volatile mercury complex;
placing a chemical sand control agent into the region containing mercury, wherein the chemical sand control agent conglomerates or consolidates the particulate HgS into packs;
producing fluids from the region;
wherein mercury concentration in produced fluids recovered from the reservoir is less than 50% of the initial concentration of mercury in the produced fluids.

2. The process of claim 1, wherein the reservoir is not producing and the initial concentration of mercury is detected by any of: a) analysis of core samples, drilling fluids, or cutting samples from the region; b) Drill Stem Tests (DST); c) Modular formation Dynamic Test (MDT); d) Repeat Formation Test (RFT); and combinations thereof.

3. The process of claim 1, wherein the reservoir is producing and the initial concentration of mercury is detected by analysis of produced fluids recovered from the region prior to placing the elemental mercury capture compound and the chemical sand control agent into the region.

4. The process of claim 1, wherein the elemental mercury capture compound and the chemical sand control agent are placed into the same region of the reservoir.

5. The process of claim 1, wherein the elemental mercury capture compound and the chemical sand control agent are placed into different regions of the reservoir, which different regions are in fluid communication.

6. The process of claim 1, wherein the elemental mercury capture compound and the chemical sand control agent are placed into the reservoir by injection via same injection stream.

7. The process of claim 1, wherein the elemental mercury capture compound and the chemical sand control agent are placed into the reservoir by injection via separate injection streams injected into the reservoir at different times.

8. The process of claim 1, wherein the elemental mercury capture compound and the chemical sand control agent are placed into the reservoir by injection via different injection streams and injected into different regions of the reservoir at different times.

9. The process of claim 1, wherein the elemental mercury capture compound and the chemical sand control agent are placed into the reservoir in any of liquid form, slurry form, dissolved form, solid form, coated particulates, and combinations thereof.

10. The process of claim 1, wherein the elemental mercury capture compound is incorporated in the chemical sand control agent as any of: a solid dispersed in the chemical sand control agent, a liquid dispersed in the chemical sand control agent, a monomer within the chemical sand control agent, a component of the polymer chain forming the chemical sand control agent, and combinations thereof.

11. The process of claim 10, wherein the elemental mercury capture compound is placed into the reservoir as a solid and incorporated in particles.

12. The process of claim 10, wherein the elemental mercury capture compound is placed into the reservoir as a coating of coated particles.

13. The process of claim 10, wherein the elemental mercury capture compound is placed into the reservoir as coated proppants.

14. The process of claim 1, wherein the elemental mercury capture compound is incorporated in the chemical sand control agent.

15. The process of claim 1, wherein the elemental mercury capture agent comprises thiourea and the chemical sand control agent comprises urea-formaldehyde.

16. The process of claim 1, wherein the chemical sand control agent comprises at least one of: aqueous tackifying treatment fluids, a curable agent, a partially cured or non-curable resin, and mixtures thereof.

17. The process of claim 15, wherein the chemical sand control agent comprises a tackifying compound and a partially cured or curable compound.

18. The process of claim 17, further comprising placing into the region at least a catalyst material to cause the partially cured or curable compound to cross-link in the formation.

19. The process of claim 1, further comprising adding a diluent to the chemical sand control agent for a concentration of chemical sand control agent in the diluent between 0.1 wt %-14 wt %.

20. A process for recovering hydrocarbons from a formation while simultaneously removing mercury, comprising:
identifying a region in the reservoir containing at least 0.1 μg/Nm³ or at least 10 ppb in total mercury as initial concentration, and wherein the initial concentration of mercury exists in both elemental mercury Hg⁰ form and particulate HgS form;
placing an elemental mercury capture compound into the region containing mercury in both elemental mercury Hg⁰ form and particulate HgS form, wherein the elemental mercury capture compound converts the elemental mercury Hg⁰ to a non-volatile mercury complex;
placing a chemical sand control agent into the region containing mercury, wherein the chemical sand control agent conglomerates or consolidates the particulate HgS into packs;
recovering hydrocarbons from the region;
wherein mercury concentration in the hydrocarbons recovered from the reservoir is less than 50% of the initial concentration of mercury.
